(19) United States
(12) Patent Application Publication
(10) Pub. No.: US 2015/0349890 A1
(43) Pub. Date: Dec. 3, 2015

(54) MODAL MUTLIPLEXED FIBER OPTIC COMMUNICATION SYSTEM AND METHOD USING A DIELECTRIC OPTICAL WAVEGUIDE STRUCTURE

(71) Applicant: Florida Institute of Technology, Melbourne, FL (US)

(72) Inventors: Barry G. Grossman, Melbourne, FL (US); Brian A. Lail, Melbourne, FL (US); Julius Chatterjee, Melbourne, FL (US); Lendon Bendix, Melbourne, FL (US)

(73) Assignee: Florida Institute of Technology, Incl, Melbourne, FL (US)

(21) Appl. No.: 14/735,061

(22) Filed: Jun. 9, 2015

Related U.S. Application Data
(63) Continuation-in-part of application No. 14/702,654, filed on May 1, 2015.
(60) Provisional application No. 62/009,554, filed on Jun. 9, 2014.
(60) Provisional application No. 61/986,974, filed on May 1, 2014.

(51) Int. Cl. H04B 10/2581; H04B 10/25; H04J 14/04; G02B 6/26; G02B 6/024

(52) U.S. Cl. CPC H04B 10/2581; G02B 6/262; G02B 6/024; H04J 14/04; H04B 10/2503

(57) ABSTRACT

A novel fiber optic modal multiplexed data communication system is shown and claimed, wherein an optical fiber end structure may comprise a truncated cylindrical wedge that is angled with respect to the longitudinal axis of the optical fiber, and further comprises a lip that is generally perpendicular to the longitudinal axis of the optical fiber on both ends of the fiber. The system and method of the invention may comprise at least one but preferably a plurality of laser transmitters to illuminate an optical fiber and at least one but preferably a plurality of optical detectors to detect radiated standing wave and linear polarized modes emanating from the fiber end face. The laser transmitters may be modulated to carry information to at least one receiver, and may comprise Forward Error Correction encoding. The invention may employ single, few mode or multimode optical fibers.

### CROSS REFERENCE TO RELATED APPLICATIONS

This non-provisional application for patent filed in the United States Patent and Trademark Office (USPTO) under 35 U.S.C. §111(a) is a non provisional of and claims the benefit of U.S. provisional patent application Ser. No. 62/009,554 “ADVANCED SYSTEM FOR MULTIMODAL MULTIPLEXED COMMUNICATION AND SENSING” filed in the USPTO on Jun. 9, 2014, which is incorporated herein by reference in its entirety; and this application is also a continuation in part (CIP) application of U.S. non-provisional patent application Ser. No. 14/702,654 “FIBER OPTIC DIELECTRIC WAVEGUIDE STRUCTURE FOR MODAL MULTIPLEXED COMMUNICATION AND METHOD OF MANUFACTURE”, filed in the USPTO on May 1, 2015, which is a non-provisional of U.S. provisional application Ser. No. 61/986,974 “FIBER OPTIC DIELECTRIC WAVEGUIDE STRUCTURE” which was filed in the USPTO on May 1, 2014, both of which are also incorporated herein in their entirety by reference.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The field of the invention relates generally to fiber optic modal multichannel communication systems which may be useful, for instance, in fiber-optic communication systems and fiber optic sensing systems in which a plurality of data sources may individually communicate data to a plurality of data sinks, one data source to one data sink, using independent modal communication channels. More specifically, the field of the invention may be generally described as a novel multi-channel duplex multimode fiber optic system and method employing a wedge-shaped fiber optic dielectric waveguide structure for optical fiber ends for radiating and/or modulating standing waveguide modes and linearly polarized modes for use in systems in which optical fibers of any type, including but not limited to single mode, few mode and multimode fibers, are utilized to communicate information or to utilize the physical characteristics of the optical fiber to provide a number of sensing functions such as, for instance and not by way of limitation, measuring temperature by analyzing the Raman scattering of photons and other sensing applications. The novel system and method for providing a multichannel duplex bidirectional fiber optic communication and/or sensing system employing data sources, data encoders, optical transmitters, an optical fiber comprising an input and output cylindrical wedge component for supporting multimodal optical communications, optical receivers, decoders, and data sinks is disclosed and claimed.

2. Background Art

Significant research energy is being expended in field of fiber optic modal multiplexing and de-multiplexing with the goal of increasing the total communication bandwidth supported by a single fiber. The typical focus of research is directed at developing an ability to communicate digital data through the dielectric waveguide (optical fiber).

Similar focus has been directed toward the ability of the dielectric waveguide modes to respond to various sensor system stimuli. Previous work performed by Lan Truong (Florida Institute of Technology) and Sachin Narahari Dekate (Florida Institute of Technology) demonstrated that modal de-multiplexing and multiplexing is possible. However, the common processes by which the optical fiber structures are currently fabricated is hazardous, is not repeatable and requires significant experience to refine the process to provide a working optical fiber capable of radiating modal rings.

Previous work in the field of fabricating structures to produce radiated modal rings from optical fibers have used a dangerous process using highly caustic chemicals. Hydrofluoric acid solutions are typically used to etch the tips of optical fibers into a cone shape. These chemicals require stringent material safety data sheet (MSDS) and storage control, which can be very costly and may be prohibitive to the facilities and handling requirements. In addition to storing the chemicals, disposing of the chemicals is dangerous and costly. The use of harsh chemicals such as hydrofluoric acid makes the methods of the prior art inefficient, unreliable, hazardous and costly for mass production.

Furthermore, the etching of an optical fiber tip using hydrofluoric acid creates a cone shape in the optical fiber tip in which the core of the fiber is etched to a very fine point, which can be problematic due to breakage. With most few mode fiber cores measuring at 8.4 microns, any vibration, sudden air currents and tapping of the optical fiber can break the conical fiber tip. If the conical fiber tip is broken the modal ring radiation is lost. The hydrofluoric etching process cannot be expected to achieve a six sigma manufacturing process. A simpler, more repeatable process is required to ensure the modal ring technology can and will be able to implement into industry. Fiber-optic communication and sensing systems are generally known in the art: such systems have been known to comprise optical fibers further comprising end shapes created by a chemical etching process, resulting in a cone shaped optical fiber tip designed to radiate modal rings from few mode fibers. Such fiber ends have historically been created by a hydrofluoric or other acid etching processes which may be characterized as non-repeatable, expensive, difficult to achieve, and utilizing a chemical process that is not friendly to the environment. The hydrofluoric etching process cannot be expected to achieve a six sigma manufacturing process and is thus not adaptable to a production environment, or even to a laboratory environment where repeatability is important. A simpler more repeatable fabrication process is required to ensure that fiber optic modal ring technology is able to transition into commercial applications for use industry.

One such process for hydrofluoric acid flow etching of conical fiber tapers is described in Hydrofluoric acid flow etching of low loss sub wavelength diameter by conical fiber tapers, Eric J. Zhang et al., Department of Electrical and Computer Engineering and the Institute for Optical Sciences, University of Toronto, Toronto, Ontario M5S3G4, Canada (“Zhang et al.”). Zhang et al. describes An etch method based on surface tension driven flows of hydrofluoric acid micro-droplets for the fabrication of low-loss, sub-wavelength-diameter bi-conical fiber tapers is presented. Tapers with losses less than 0.1 dB/mm were demonstrated, corresponding to an order of magnitude increase in the optical transmission over previous acid-etch techniques. The etch method produces adiabatic taper transitions with minimal surface corrugations. However, it is obvious from the text of Zhang et al. that the processes described therein for chemically etching optical fibers is not mass-repeatable, economic, or environmentally friendly as is typical of the acid-based optical fiber etching processes known in the art.

What is needed in the art are optical communications systems capable of supporting a plurality of independent communication channels, using independent excited modes in an optical fiber in which the fiber has been modified to allow such modes to be excited, to propagate and to exit the optical fiber such that they may be independently received by independent optical receivers, could be constructed using repeatable methods for fabricating the optical fiber end faces for receiving and outputting independent optical modes. What is also needed in the art is an economic, repeatable, highly reliable and environmentally friendly method and structure for creating optical fiber modal multichannel duplex devices that may be utilized to modulate an excitation source by amplitude, phase and/or frequency in single mode, few mode, and multimode fiber optic communications and sensing systems. The present invention provides such features by creating a unique wedge and lip shaped optical dielectric waveguide end face using a novel and repeatable mechanical polishing method, and by providing an end-to-end multimodal optical communication system, all of which is claimed.

### BRIEF SUMMARY OF THE INVENTION

The present invention comprises a novel system and method for providing a multichannel fiber optic system employing a cylindrical wedge and lip component on both ends of a fiber optic dielectric structure. The system and method of the invention may operate bi-directionally or uni-directionally, and may be full duplex or other than full duplex.

In accordance with one embodiment of the present invention, the invention comprises a multimodal multiplexed fiber optic communication and/or sensor system, employing a novel optical fiber end face structure and method for creating the novel optical fiber end structure, wherein both ends of an optical fiber comprise a wedge that is angled with respect to the longitudinal axis of the optical fiber, and further comprises a flat surface, or lip, that may be generally perpendicular to the longitudinal axis of the optical fiber as shown as described in further detail in the figures of the drawings and in the detailed description of the invention herein. The method and FODWWS device of the invention employs a single or plurality of mechanically polished wedges on the end or ends of an optical fiber, which may be, but is not necessarily, a few mode optical fiber. “Few mode fiber” or “Few mode optical fiber” as used herein refers to an optical fiber that supports only a few optical modes, for example less than four, and is capable of low dispersion operation such as, for example, a total dispersion of less than 5 ps/km-nm. Such a few mode fiber is described in U.S. Pat. No. 4,877,304 to Bhagavatula, issued from the USPTO on Oct. 31, 1989, which is herein incorporated by reference in its entirety. The system and method of the invention may employ one or a plurality of optical sources, which may be, for example, laser diodes, transmitting light energy into an optical fiber comprising the wedge and lip-shaped FODWWS structure at its input end as defined further herein. Light energy may propagate the length of the fiber and exit an opposing end (the “exit end”) of the optical fiber which may also comprise the wedge and lip-shaped structure defined herein. The exit end of the FODWWS may radiate Linearly Polarized (“LP”) modes and/or Standing Wave (“SW”) modes of optical energy. The optical fiber comprising the FODWWS may be a multimode, single mode, or few mode optical fiber. The method and device of the invention may modulate and radiate standing waveguide modes and linearly polarized modes in optical fibers, which may be few mode optical fibers, or may be multimode or single mode optical fibers as further described herein.

The inventors of the present invention performed research of theoretical modeling and experimental validation of the modal energy of independent optical modes of propagating light in a few mode fiber with mechanically polished Fiber Optic Dielectric Waveguide Wedge Structure (FODWWS) as a method of measuring modal energy in a fiber. It was discovered that the only way to achieve a consistent and repeatable measurement of the simulation is to create a device that not only radiates the linearly polarized modes of cylindrical optical fiber wave guides, but also allows for the resonant or standing wave guided modes to be simultaneously measured. Linearly polarized optical fiber wave guide modes are developed by hybrid degenerative modes. It was discovered that both a combined cylindrical and slab waveguide combination were required in order to radiate the desired independent modal content for accurate validation of the simulations results.

In one embodiment, the invention is a system and method for a multi-modal communication system using the fiber optic dielectric waveguide wedge structure (FODWWS) of the invention that both modulates and demodulates standing waveguide modes and linearly polarized waveguide modes and is hence an improved modal multiplexing and de-multiplexing structure and method. The same system can be used for either modal multiplexed communication, sensing applications, or both. Specific modulation capabilities of the system include amplitude and phase modulation methods. Frequency modulation is possible by varying the wavelength of the excitation source(s). The unique and innovative application of the FODWWS provides a safer method of creating a communications or sensing system which uses modal multiplexing. The FODWWS is significantly more reliable and repeatable for mass production than the methods and structures of the prior art, which relied upon the use of caustic chemicals.

Although the exemplary embodiments depicted herein describe using a few mode optical fiber as the exemplary optical fiber embodiment for this invention, the scope of the invention includes implementing the FODWWS with other fiber optic waveguides such as multimode fibers and single mode fibers, and all such other embodiments are to be considered within the scope of the claimed invention. The cylindrical waveguide and slab wave guide are created by using a length of optical fiber and mechanically polishing the end of the fiber into an angle θ between 5 and 95 degrees relative to the longitudinal axis of the optical fiber. This process creates an optical fiber tip in the shape of a truncated cylindrical wedge that comprises a planar surface that is disposed at an angle to the longitudinal axis of the optical fiber, and a planar lip surface disposed at a desired angle to the longitudinal axis of the optical fiber but is preferably perpendicular to the longitudinal axis. The lip height may be any predetermined height but is preferably greater than the cladding thickness. Unlike current polishing processes, the claimed FODWWS and process for fabricating the FODWWS of the invention allows optical energy to radiate below the curved part of the FODWWS. An additional very unique polishing tip shape is the FODWWS with a small un-polished flat end, or lip, that may be substantially perpendicular to the longitudinal axis of the optical fiber. This lip allows for the de-multiplexing of linear polarized modes. In a preferred embodiment, the invention comprises a modal multiplexing and de-multiplexing system that further comprises a FODWWS disposed on both the transmitting and receiving end of an optical fiber. The present invention is further novel in that it may utilize both linearly polarized and standing waveguide modes established by the FODWWS as independent communication channels. Unlike other work conducted in the art, the present invention does not simplify the linear polarized field equations to a set of four differential equations. The present invention, in a preferred embodiment, includes the z direction or axial field equations of the cylindrical waveguide structure. This is required based on the internal reflections of both the core/cladding interface and the source/receiver axial ends of the few mode fiber. Linearly polarized modes are created by the very small difference between the core cladding indices. This small difference in indices enables allowed hybrid Electric Magnetic fields (EH) and the Magnetic Electric fields (EH) to propagate simultaneously.

Modal multiplexing and de-multiplexing of the various embodiments of the invention are achieved by the modulation of allowed electric fields (modes) of the dielectric cylindrical waveguide FODWWS interface. The system of the invention may comprise an optical fiber with a source or “input” FODWWS end, and a detector or “output” FODWWS end. A FODWWS is typically, but not necessarily, disposed on both the input and output ends of the optical fiber in order to create the selected modal modulation by the excitation sources.

In a typical fiber optic communication system of the prior art, the input end of the optical fiber is typically cleaved, creating a fiber end face having a 90° angle to the longitudinal axis of the optical fiber. When the input end of a cylindrical dielectric wave guide (optical fiber) of the prior art is illuminated by multiple optical sources such as lasers, a significant number of hybrid electric and magnetic fields are established from the core/cladding interface. This interface will create significant inter modal modulation as a result of the very small indices difference between the core and cladding material. This limitation of the prior art is overcome by the FODWWS of the invention so as to achieve successful modal multiplexing and de-multiplexing with greatly reduced inter modal modulation. Consequently, multiple channel modulation is possible in a single fiber using the FODWWS of the invention.

The FODWWS enables the optical modal multiplexer and de-multiplexer to be effective. As shown in detail herein, the FODWWS can be created reliably and repeatable without harsh chemicals and thus inherently increases the safety of fabrication of the system.

One aspect of this invention comprises the improved modal multiplexing and de-multiplexing of a few mode optical fiber which is operated at a wavelength that establishes a plurality of propagating modes. This may be achieved by utilizing one or more laser sources, but preferably a system of a plurality of laser excitation sources, to illuminate a few mode fiber comprising the FODWWS of the invention on both ends, and by utilizing at least one, but preferably a plurality, of optical detectors at the FODWWS output end of the optical fiber to receive optical energy exiting the output FODWWS. The plurality of optical detectors may be arranged in a linear array. Modal multiplexing is achieved by the use of the FODWWS. Any process that does not change the material characteristics of permittivity and permeability can be used to shape the fiber end into an FODWWS. A linear array of optical detectors for detecting the optical modes radiated at the exit end face of the optical fiber of the invention can be created and fabricated by any number of existing methods.

The present method for creating the FODWWS overcomes the shortcomings of the prior art by eliminating the need for expensive and environmentally problematic use of acids, such as hydrofluoric acid, to etch optical fiber ends as has been previously required in the art, and further provides significant improvement in repeatability, reliability, cost savings and reduced risk over the prior art.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1A depicts standing wave energy radiated from the output end of a FODWWS of the invention comprising a few mode fiber with wedge angle θ of 45 degrees.

FIG. 1B depicts standing wave energy radiated from the output end of a FODWWS of the invention comprising a few mode fiber with wedge angle θ of greater than 60 degrees.

FIG. 2 depicts linearly polarized modes radiated from the output end of a FODWWS of the invention, in which the optical fiber is SMF-28E few mode fiber manufactured by Corning® Incorporated, One Riverfront Plaza, Corning, N.Y. 14831 USA.

FIG. 3 depicts an exemplary output beam profile of a 90 degree cleaved or polished SMF-28E fiber when excited by a 650 nm optical source.

FIG. 4 depicts a side view of an exemplary embodiment of the FODWWS of the invention, depicting laser sources illuminating an input end of a FODWWS

FIG. 5 depicts an exemplary method for communicating independent modal channels within a fiber optical dielectric waveguide, producing a multi-channel modally multiplexed communication system.

FIG. 6A depicts an exemplary system block diagram of a multimodal communication system of an embodiment of the invention, comprising data source(s), encoder(s), laser excitation source(s), an optical fiber comprising an FODWWS of the invention on both a receive and a transmit end, optical detector(s), receivers, decoder(s), and data sink(s).

FIG. 6A depicts an exemplary system block diagram of a multimodal communication system of an embodiment of the invention, comprising data source(s), encoder(s), laser excitation source(s), an optical fiber comprising an FODWWS of the invention on both a receive and a transmit end, optical detector(s), receivers, decoder(s), and data sink(s).

FIG. 7A depicts an exemplary embodiment of the steps of a polishing method of the invention.

FIG. 7B depicts a view of an exemplary embodiment of the mechanical polishing fixture of the invention.

FIG. 7C depicts a view of an exemplary embodiment of the mechanical polishing fixture of the invention.

FIG. 8 depicts the longitudinal propagation of light energy propagating in a fiber.

FIG. 9A depicts a side view of a preferred embodiment and best mode of the fiber optic dielectric waveguide structure (FODWWS), depicting the geometry of the FODWWS and showing the fiber material that is removed in the fabrication of the FODWWS.

FIG. 9B depicts an end view of a preferred embodiment and best mode of the fiber optic dielectric waveguide structure.

FIG. 10 depicts exemplary standing waves modes and linear polarized modes radiated from the output end of a preferred embodiment and best mode of the FODWWS.

### DETAILED DESCRIPTION OF THE INVENTION

The following documentation provides a detailed description of the invention. The embodiments of the invention described herein and depicted in the figures of the drawings are exemplary. The scope and breadth of the invention include all equivalents of the features and elements of the described and claimed invention.

Fiber optic communications systems, as well as fiber optic sensor systems, generally rely upon the propagation of light along a longitudinal axis of an optical fiber. It is generally the point of such communications and/or sensor systems to modulate the propagated light in response to an external stimulus which may be, for instance, environmental conditions such as pressure or temperature, or may be an information system transmitting, for example, digital, analog or some other form of information. The means for coupling light energy into and out of an optical fiber at the fiber end faces is a critical element of any such communication or sensor system. The efficient and controllable coupling of light energy into and out of an optical fiber at the fiber interfaces may depend on a number of factors including the quality of the end face surface in terms of surface irregularities in relationship to the wavelengths of light energy present in the fiber, the angle, if any of the fiber end face compared to the longitudinal axis of the fiber, and the difference in index of refraction between the core and cladding of the optical fiber and the medium with which it interfaces. In many instances, this interface is air.

One aspect of this invention is the implementation of the FODWWS into an advanced modal multiplexing and de-multiplexing system. The invention also comprises a method for fabricating the FODWWS f the invention, which makes modal multiplexing and de-multiplexing possible, without the use of harsh chemicals such as hydrofluoric acid. In one aspect of the invention, optical energy such as that produced by a laser excites the input end FODWWS of the fiber, excites certain modes in the fiber. The excited optical modes propagate the length of the fiber, and are in turn radiated as both standing and linearly polarized modes from the FODWWS comprising the output end of the fiber.

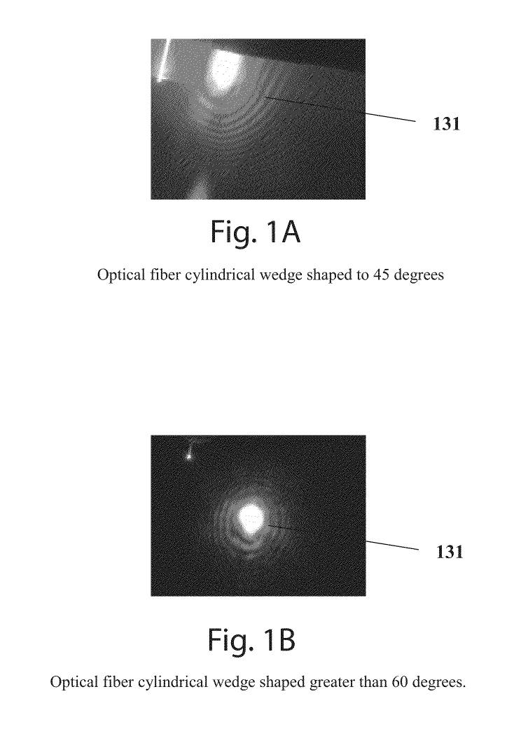

FIGS. 1A and 1B depict the radiated optical energy from the lower surface of the SMF-28E FODWWS. Depending on the angle of the polished FODWWS, the radiated energy may establish modal semicircle rings 131 such as, for example, those depicted in FIG. 1A in which the FODWWS has been polished to a 45 degree angle θ as one of many embodiments of the invention. If the FODWWS is polished to a shallower angle, such as, for example, 60 degrees, the various standing wave modes 131 radiated from the FODWWS are shown in FIG. 1B. Relative to the previous methods of etching the few mode fibers into conical points with hydrofluoric acid which is highly corrosive, the polishing of the fiber into the FODWWS shape using the method and apparatus of the invention can be achieved reliably, repeatedly and with reduced cost. Mass production of FODWWS systems, each of which exhibit increased information bandwidth due to modal multiplexing, is now possible using the method and apparatus of the invention: and, because the method of manufacturing the FODWWS does not rely upon dangerous chemicals, there are significantly fewer safety concerns for technicians and for the environment.

Many methods of exciting the few mode fiber standing waves within a FODWWS are possible. The example demonstrated in FIGS. 1A and 1B above is the SMF-28E fiber excited by a 1.2 milliwatt 650 nm continuous wave laser source. The energy is coupled into the fiber by a standard FIS connector. These connectors are very well known by those skilled in the art. Another method of excitation is the focused radiated energy at the bottom of the FODWWS. In this application the few mode fiber may have a FODWWS on both ends of the fiber. One end is excited by the focused energy at a specific point on the lower side of the FODWWS so as to excite the specific electric fields in the fiber optic wave guide. Each mode is an allowed sustained electric field within the cylindrical wave guide structure. It is the cylindrical wave guide to FODWWS structure that supports the ability to excite individual modes. By exciting a number of points of the FODWWS simultaneously, each mode can be a modulated communications channel.

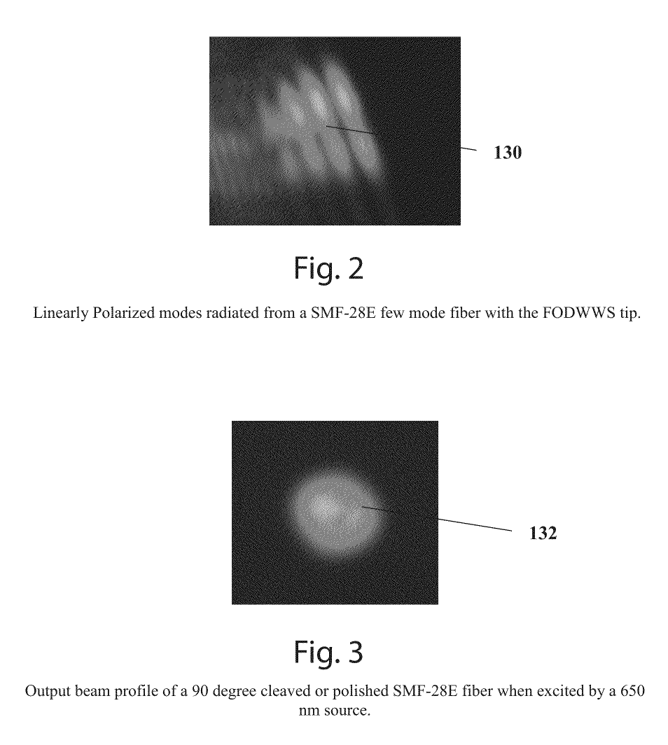

Linearly Polarized (LP) or hybrid modes are also capable of being modulated by an excitation source radiating into a few mode fiber with the cylindrical waveguide/FODWWS structure. Linearly polarized modes are modulated in the same manner as the standing wave guide modes. A small section of the FODWWS lower surface is not polished on the cladding thus forming a lip. This focuses the energy into the LP modes of the cylindrical waveguide. FIG. 2 depicts the same SMF-28E few mode fiber with the FODWWS is excited by the 650 nanometer laser. The radiated energy 130 from the output end of the FODWWS, which may comprise a cylindrical optical waveguide with a polished FODWWS, is demonstrated as four linear polarized modes with variations in intensity, length and thickness. The normalized frequency or V number supports the number of observed radiated modes. Although the example presented herein uses the few mode fiber, this is exemplary only and the invention may comprise other dielectric filled fiber optic waveguides.

Referring still to FIGS. 1A and 1B, light energy propagating an optical fiber may be described using mode theory which relies upon a view of the propagating light energy as an electromagnetic wave propagating through the optical fiber. Many methods of exciting the few mode fiber standing waves within a FODWWS are possible. The example demonstrated in FIGS. 1A and 1B is the SMF-28E fiber excited by a 1.2 mill watt 650 nm continuous wave laser source. The energy is coupled into the fiber by a standard FIS connector. These connectors are well known in the art. Another method of excitation is the focused radiated energy at the bottom of the FODWWS. In this application the few mode fiber will have a FODWWS on both ends of the fiber. One end is excited by the focused energy at a specific point on the lower side of the FODWWS so as to excite the specific electric fields in the fiber optic wave guide. Each mode is an allowed sustained electric field within the cylindrical wave guide structure. It is the cylindrical wave guide FODWWS structure that provides the ability to excite individual modes. By exciting a number of points of the FODWWS input end simultaneously with optical energy from an optical source such as a laser, each mode can effectively be utilized as an independently modulated communications channel, allowing for multi modal communication in a single optical fiber, each channel supported by one of the excited optical modes.

Linearly Polarized (LP) or hybrid modes are also capable of being modulated by an excitation source radiating into a few mode fiber comprising an FODWWS structure on its input end. Linearly polarized modes are modulated in the same manner as the standing wave guide modes. A small section of the FODWWS lower surface is present on the cladding thus forming a lip. This focuses the energy into the LP modes of the cylindrical waveguide. FIG. 2 depicts the same SMF-28E few mode fiber as FIGS. 1A and 1B, with the FODWWS acting as a receiver structure excited by the 650 nanometer laser. The radiated energy from the cylindrical waveguide with a polished FODWWS output end is depicted in FIG. 2 as four linear polarized modes 130 with variations in intensity, length and thickness. The normalized frequency, or V number, supports the number of observed radiated linear polarized modes 130. Although the example of this invention depicted and described herein uses the few mode fiber, this does not preclude other dielectric filled fiber optic waveguides. The optical fiber may be treated as a dielectric waveguide that may support propagation of many modes of light energy, wherein the optical fiber comprises a core having a first index of refraction n₁, and a cladding having a second index of refraction n₂. For a particular mode, the propagating optical wave is effectively confined within the optical fiber, or waveguide, and the electric field distribution in the X direction does not change as the wave propagates in the Z, or longitudinal, direction.

Although the examples presented herein describe the use of a few mode optical fiber in an embodiment of the invention, the use of a few mode optical fiber is exemplary only and the invention may comprise other fiber optic waveguides such as multi-mode or single mode optical fibers.

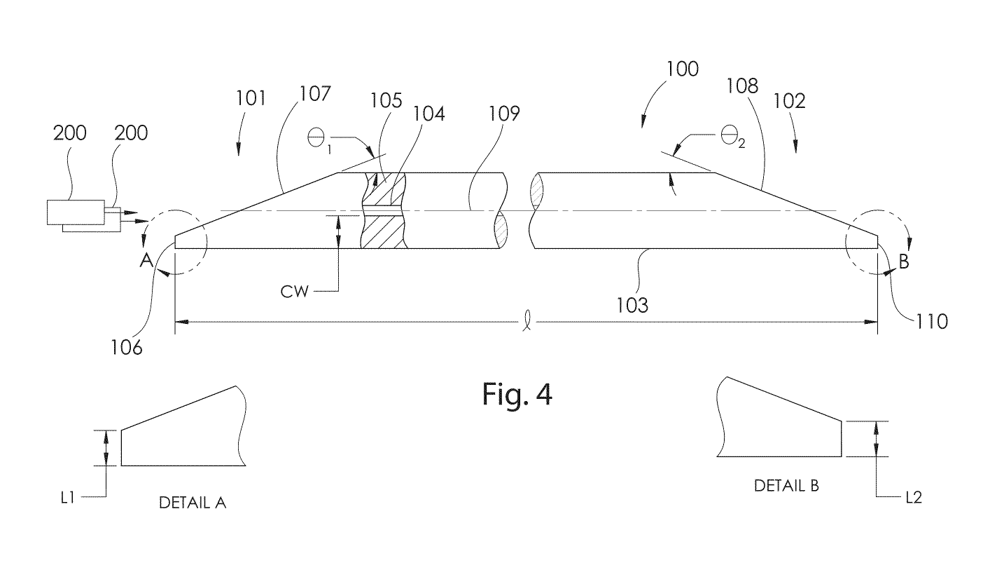

As a reference, and to illustrate that the systems of the prior art do not support modal multiplexing, a standard 90 degree cleaved angle or polished optical fiber surface of the prior art may radiate output energy as depicted in FIG. 3. FIG. 3 depicts radiated energy 132 from a length of SMF-28E fiber that has merely been cleaved and polished to 90 degrees as is done in the prior art. FIG. 3 clearly shows that the optical energy radiating from the cleaved 90 degree end face of the SMF-28E fiber end face, typical of the prior art, which is excited by a 650 nanometer source, is not spatially separated into independently identifiable modes. For an optical system to function as a communications method employing modal multiplexing, the system must have the ability to separate and demodulate the individual modes. FIG. 3 demonstrates that the 90 degree cleaved or polished fiber end faces of the prior art clearly do not allow for the radiation of individually identifiable modes, either standing wave or linearly polarized, and thus modal multiplexing is not possible with the 90 degree cleaved or polished fiber end faces of the prior art. In order to achieve modal multiplexing, the FODWWS of the invention is needed.

While any type of modulation may be employed by the system of the invention, three basic types of modulation are conceived as the best modes and preferred embodiments in this invention: frequency modulation, amplitude modulation, and phase modulation. Depending on the modulation method used for exciting the individual modes of the fiber by the FODWWS, information, which may be digital or analog data, may be excited onto the guided optical modes. The invention is capable of multiple channel simultaneous digital communications.

As a result of modulating individual optical modes simultaneously, some intermodal modulation may occur, causing data errors in the individual communication channels. An embodiment of the system of the invention employs forward error correction techniques. By employing these techniques, the data error rate caused by intermodal modulation and self-generated noise of the invention are reduced.

Forward error correction (FEC) may be employed by standard algorithms familiar to those in the art. Many fiber optic communication systems do not require FEC techniques since the optical pulses may be enhanced by such components as erbium doped amplifiers. Pulses may thus be reconstructed at points where the pulse dispersion or a loss of energy might take place. For those familiar with the normal VHF and UHF phase modulation radios, FEC is used extensively in the reconstruction of digital data at the receiving end of the communication system to correct for error in the transmitted data that may be caused by such phenomena as non-linear characteristics in the communication channel. Data may be lost by noise, phase modulation, cross talk and other issues which might reduce the signal integrity. In this particular application of the invention, noise from phase variations might create some modal cross talk that would be expected to degrade the ability to decode intelligence on a carrier or mode. Thus, the invention may comprise FEC techniques to recover data errors caused by inter-modal crosstalk effects or other data error-causing effects.

The optical modes propagated in the cylindrical waveguide of the invention are a function of optical fiber core size and source wavelength. Multiple excitation sources illuminating the optical fiber entry end face at different angles has been demonstrated by Murshid et al. to excite skew modes in the fiber by the angle at which the laser enters the core. Murshid et al. also defines the method of excitation as skew modes in multimode fibers. As opposed to the work of Murshid et al., the present invention excites individual modes of a dielectric waveguide as an implementation of Maxwell's equations with defined boundary conditions. Skew mode high frequency analysis as done in the prior art cannot describe the dielectric wave guide response to refraction and phase variations. These allowed individual modes include all modes predicted by Maxwell's equations. An additional variation of the work of Murshid et al., this invention does not angle the excitation source into the 90 degree cleaved edge of a multimode fiber. This invention modulates individual modes by focusing directed energy at specific locations of the input FODWWS.

Waveguide modes are created by the allowed Eigen value, or distinct allowed electromagnetic electric fields which will propagate in the given wave guide geometry. A 90 degree cleaved fiber can be excited by a laser source along the axis of its core. This excitation source will establish linearly polarized modes as is demonstrated in equation (1). To those familiar in the art, this is the normalized frequency, commonly defined as the V number. The V number is 2.4 or less for single mode propagation. If the V number for a particular fiber and wavelength combination is between 2.4 and 12 then that optical fiber will operate as a few mode optical fiber. The famed Gloge chart is a method of accurately estimating the very complex function of linearly polarized modes. This invention decreases the source wavelength to allow for more modes to propagate in the core of the few mode fiber. Linear polarized modes are also Degenerative Hybrid modes. They are also referred to as lossy modes.

V=2π/λNA (Equation 1)

Degenerative modes are defined as a set of allowed propagating modes along the longitudinal axis of the fiber and containing the same exponential field variations. These same modes will, however, have different configurations in any transverse cross section of the fiber core. As an example, the LP01 mode would consist traditionally of 2 HE11 modes. These two modes will have the same hybrid magnetic-electric fields along the axis, but can and will vary along the cross section or transverse part of the core. Those skilled in the art will further understand each hybrid mode can propagate along the fiber axis independently. This invention takes advantage of the cross sectional variation of the allowed fields to modulate modes propagating through a few mode optical fiber core. This differs from the work of Murshid et al., which does not consider reflected waves and standing waveguide modes as a method of modulating and creating modal communications multiplexing.

Conventionally the use of the normalized frequency is used as a simplification of very complex electromagnetic propagation equations. This simplification is derived from the assumptions the indices of refraction within the core and cladding interface is very small, thus only four of the six of the hybrid electromagnetic equation field components are considered. In this invention a detailed evaluation of the six allowed hybrid modes is required. This implies that the allowed Hz and Ez modes must also be considered due to the FODWWS/cylindrical waveguide interface. The core wave guide variation sets up reflected power within the cylindrical waveguide structure. For this invention, the linear polarized modes must also consider the axial Electric and Magnetic field propagation.

Referring to the example of the invention resulting in the patterns of FIGS. 1A and 1B, 14 semi-rings are observed in the picture radiating from the output end of the FODWWS. These modes are the allowed standing wave modes for a cylindrical waveguide excited by the 650 nm source. In FIG. 2, the linearly polarized modes which are defined by the normalized frequency are demonstrated. Notice that four of the allowed LP modes are the dominate modes in this particular example. Thus, 14 independent standing wave modes and 4 individual linear polarized modes are possible, for a total of 18 independent modes, each capable of supporting a separate communication or sensor information channel. In the particular case shown in FIGS. 1A and 1B, each of the 18 independent standing wave and linearly polarized modal channels may be excited by independent optical sources, such as, for example, lasers, and may be received by independent optical detectors, allowing for eighteen independent optical modal channels and creating a modal multiplexed communication or sensing system in a single optical fiber. This is but one example of the modal multiplexed system of the invention: the invention may comprise any number of independent optical modal channels with associated independent optical sources and optical detectors.

As used herein, “photodetector” and “optical detector” or simply “detector” are used to identify a device capable of receiving optical energy, converting the optical energy to a corresponding electrical signal, and outputting the corresponding signal. The conversion may be, but is not necessarily, linear. The output signal may be optical, electrical, or wireless in nature.

As used herein, “receiver” is used to identify a device capable of receiving a signal corresponding to an optical signal that has been received and converted by an optical detector to a corresponding signal, and converting the corresponding signal to a signal of a specific desired format such as a specific digital format, analog format, or other desired format.

As used herein, “communication” or “in communication with”, unless otherwise specified, is used to identify any known means of communication known the corresponding art such as, but not limited to, optical communication, electrical communication, and wireless communication.

As used herein, “optical source” may include a modulator that receives data, encoded or un-encoded, modulates said data onto an optical signal, and outputs the modulated optical signal. Optical sources may comprise lasers of any type, laser diodes, Light Emitting Diodes (LEDs) or any other light source capable of exciting a linearly polarized or standing wave mode in an FODWWS.

As used herein, “data source” means any device or system that provides data.

As used herein, “data sink” means any device or system that receives data.

The input side of the system of the invention may use multiple laser sources to excite independent optical modes in the FODWWS. In contrast to the present invention, it is generally not possible to excite the individual modes by an excitation source into a 90 degree cleaved fiber. Such direct axial and slightly off axial radiation creates significant intermodal modulation and distortion. In order to individually excite the allowed modes in the fiber, the FODWWS is required.

Amplitude modulation can be achieved by stimulating the allowed modes propagating along the core. The invention may establish the fundamental fields by a constant source power level. Additional variations in the core modal fields may be amplitude modulated by pulsing each mode independently by direct excitation of the input FODWWS. Phase modulation can be achieved by the pulsing of the source laser relative to a reference laser. Frequency modulation can be achieved by shifting the fundamental frequency wavelength.

The invention both transmits and receives from the FODWWS. A few mode fiber with the cylindrical wedge on the source or transmitter side may excite the fundamental modes. The invention may employ multiple source lasers FODWWS excitation to modulate defined modes. Modulated modes will propagate through the fiber to the exit end of the optical fiber which may also be termed the receiving FODWWS. Energy is then radiated from the exit end of the optical fiber and may be received by at least one optical detector diode such as a PIN diode, but is preferably received by a linear array of detector. The linear optical detector array of the preferred embodiment of the invention is simple and less complex than other optical detectors in that it does not require exotic patterns in order to operate.

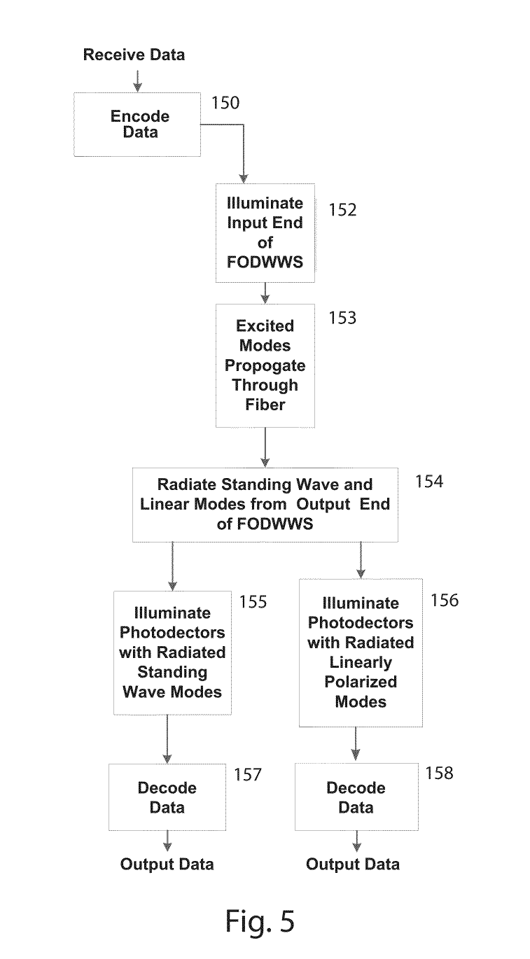

FIG. 4 depicts an embodiment of the optical fiber with FODWWS on both ends 100 comprising an optical fiber 103, which may be a few mode fiber, single mode fiber, or multimode optical fiber: an input FODWWS truncated cylindrical wedge structure 101 and an output FODWWS truncated cylindrical wedge structure 102. In a typical application, the optical fiber may be defined as having an input end comprising an FODWWS 101, an output end comprising an FODWWS 102, a core 104, and a cladding 105 wherein core 104 and cladding 105 are cylindrically shaped and coaxially disposed about said longitudinal axis, and wherein core 104 is defined as having a first index of refraction n1 and cladding 105 is defined as having a second index of refraction n2, and wherein core 104 is further defined by a cross section having a radius, and wherein cladding 105 is further defined as being concentrically disposed about the core and having a cross section defined as a ring having an inner cladding radius and an outer cladding radius, where cladding thickness CW is defined as the difference between the inner cladding radius and the outer cladding radius. Input FODWWS truncated cylindrical wedge structure 101 may comprise an angled end face 107 that is a planar surface oriented at angle θ₁ to the longitudinal axis 109 of optical fiber 103. Input FODWWS 101 may also comprise a lip 106 of height L1 that is preferably, but not necessarily, disposed substantially perpendicular to optical fiber longitudinal axis 109 as depicted in Detail A. Output FODWWS truncated cylindrical wedge structure 102 may comprise an angled end face 108 that is a planar surface oriented at angle θ₂ to the longitudinal axis 109 of optical fiber 103. Output FODWWS truncated cylindrical wedge structure 102 may also comprise a lip 110 of height L2 that is disposed substantially perpendicular to optical fiber longitudinal axis 109 as depicted in Detail B. In an embodiment of the invention, θ₁ may be equal to θ₂, and height L1 may be equal to L2. However, it is not necessary that θ₁ be equal to θ₂ or that height L1 be equal to L2. In an embodiment of the invention, core index of refraction n1 may be greater than cladding index of refraction n2. Heights L1 and L2 may be any dimension but are preferably greater than the cladding thickness. Optical fiber 103 may comprise a core 104 and a cladding 105. Cladding 105 may have cladding wall thickness CW.

Still referring to FIG. 4, one or a plurality of optical excitation sources 200, which may be for example laser diodes, may be used as sources of optical energy that couple optical energy into input FODWWS 101 in order to excite standing wave modes and linearly polarized modes within fiber 103. The invention may comprise any number of optical sources 200.

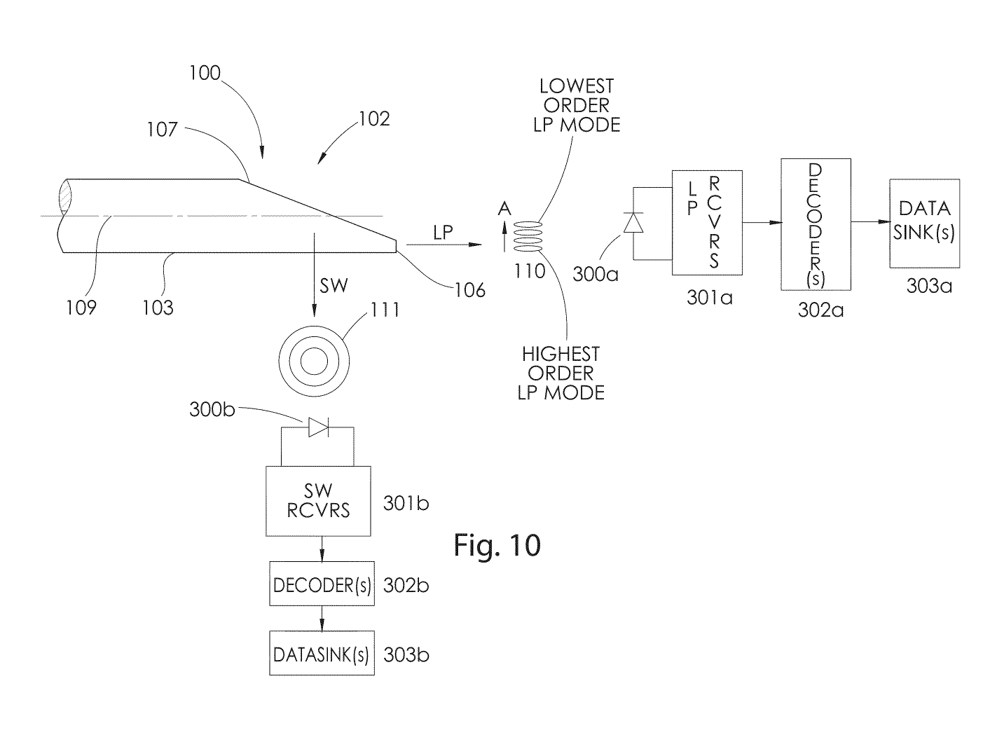

Referring briefly now to FIG. 10, the optical energy coupled into input FODWWS 101 of the optical fiber with FODWWS ends 100 from the optical source(s) propagates along the length of optical fiber 103 to output end FODWWS 102, where the optical energy encounters angled end face planar surfaces 107 and lip 106. The optical energy then exits output end FODWWS 102 as either linear polarized modes 110 or standing wave modes 111. Linear polarized modes 110 may exit and radiate from output FODWWS end 102 in the direction of arrow LP to illuminate photodetector array 300a, which is in optical communication with output FODWWS end 102 and which may be in electrical communication with receiver array 301a. The linearly polarized modes may be spatially separated by operation of output end FODWWS 102 so that they may each illuminate and be in optical communication with individual, specific photodetectors comprising photodetector array 300a. The radiated linearly polarized modes 110 may be spatially separated in order from lowest to highest as shown in FIG. 10. In this manner, individually radiated linearly polarized modes may be individually detected by the individual photodetectors in array 300a producing an electrical output signal from each photodetector. Each photodetector may be in electrical communication with a receiver comprising receiver array 301a, and, in turn, each receiver comprising receiver array 301a may be in communication with a decoder comprising decoder array 302a. Each receiver may comprise a demodulator that may operate to demodulate the signal produced by its associated receiver, producing a demodulated signal that may be communicated to a decoder comprising decoder array 302a. Thus each detected linearly polarized mode may be individually demodulated, and, if Forward Error Correction (FEC) has been employed, decoded in the decoder array 302a. The LP RCVR array may comprise any number of independent receive channels, each comprising a photodector in communication with a receiver that may comprise a demodulator, which is in turn in communication with a decoder, which may in turn be in electrical communication with a data sink. Each of the detector diodes in photodetector array 300a may be physically disposed so as to be in optical communication with and receive a specific linearly polarized mode of optical energy 110 radiating from output FODWWS 102.

Still referring to FIG. 10, standing wave modes 111 modes may exit and radiate from output FODWWS 102 in the direction of arrow SW to illuminate photodetector array 300b, which is in optical communication with output FODWWS end 102 and which may be in electrical communication with receiver array 301b. The standing wave modes 111 may be spatially separated so that they may illuminate and be in optical communication with individual, specific photodetectors making up photodetector array 300b. In this manner, individually radiated standing wave modes may be individually detected by the individual photodetectors in array 300b producing an electrical output signal from each photodetector. Each photodetector may be in communication with a receiver comprising receiver array 301b, and, in turn, each receiver comprising receiver array 301b may be in communication with a decoder comprising decoder array 302b. Each receiver may comprise a demodulator that may operate to demodulate the signal produced by its associated receiver, producing a demodulated signal that may be communicated to a decoder comprising decoder array 302b. Thus each detected standing wave mode may be individually demodulated, and, if Forward Error Correction (FEC) has been employed, decoded in the decoder array 302b. The receiver array 301b may comprise any number of independent receive channels, each comprising a photodetector in communication with a receiver that may comprise a demodulator, which is in turn in communication with a decoder, which may in turn be in electrical communication with a data sink. Each of the detector diodes in photodetector array 300b may be physically disposed so as to be in optical communication with and receive a specific standing wave mode of optical energy 111 radiating from output FODWWS 102.

Thus the invention, in an embodiment, comprises a communication system of having one or a plurality of independent communication channels, and exhibiting greatly increased bandwidth over the non-multiplexed fiber optic systems of the prior art.

Referring now to FIGS. 4 and 10, each of the detector diodes of arrays 300a and 300b may be physically disposed so as to be in optical communication with and receive a specific mode of optical energy radiating from output FODWWS 102. The invention may comprise any number of detectors 300a and 300b. In an optional embodiment of the invention, each radiating mode may be received by a detector disposed to receive it, so that the number of detectors 300a and 300b correlates to the number of modes radiating from output FODWWS 102. Thus, in an embodiment of the invention, the number of detectors 300 equals the number of optical excitation sources 200. The amount of energy in the standing wave modes 111 may be dependent on the indices of refraction of fiber core and air interface mediums. The photodetectors of 300a and 300b may be photodiodes may individual diodes set at a distance from the output FODWWS 102, or may alternatively be disposed in a single semiconductor structure which forms an array of photo detectors disposed such that each mode radiated from output FODWWS end 102 is in optical communication with and received by at least one photodiode. In either case, the detector diode array(s) may be linear and spaced at predetermined distances to allow for the detection of either the linear polarized modes, or the standing wave modes of the radiated energy. From output FODWWS end 102, energy may be radiated from the lower side of the FODWWS onto a linear array of detector diodes. The amount of optical energy in the standing wave modes 111 and/or linearly polarized modes 110 radiating from output FODWWS end 102 is dependent on the indices of refraction of fiber core and air interface mediums. At the output end FODWWS 102 of the few mode fiber, the variation of indices of refraction between the waveguide medium and air at both the core and cladding interface with air creates an evanescent field on the surface of the cylindrical wedge. It is this field that reflects the standing wave mode energy below the cylindrical wedge wave guide structure as shown by arrow SW.

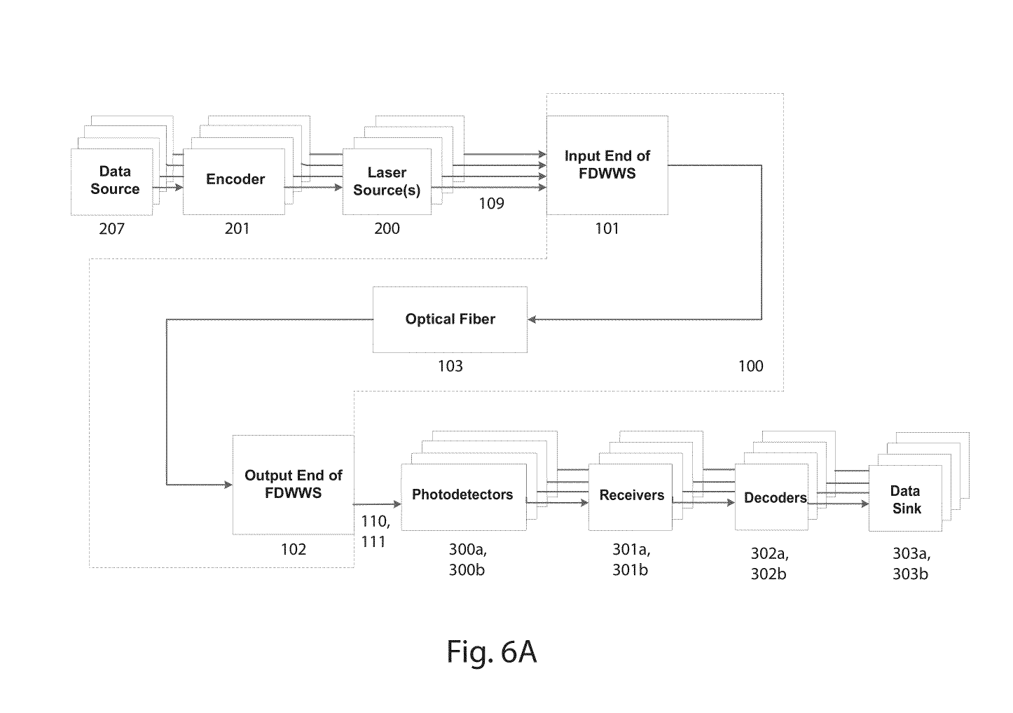

FIG. 5 depicts an exemplary method of the steps of using the FODWWS of the invention for a single communication channel of the invention. In a first step 150, data is received from a data source and is encoded using, for example, Forward Error Correction (FEC) coding, resulting in an encoded data stream. Next, in step 152, the encoded data stream is used to excite at least one optical excitation source that is positioned and otherwise disposed so as to illuminate the FODWWS input end in order to couple its output optical energy comprised optical encoded data into the input FODWWS end 101 as described elsewhere herein, so that the optical excitation source is in optical communication with the input FODWWS end 101, causing standing wave optical modes, or linearly polarized optical modes, or both, to be excited in the optical fiber. The standing wave modes, or linearly polarized modes, or both, propagate the length of the fiber 103 in step 153 to the output FODWWS where they are radiated from the output FODWWS end 102 in step 154. The radiated standing waves are received by photodectors that are disposed to receive the radiated standing wave energy as described elsewhere herein in step 155, and the radiated linearly polarized modes are received by photodectors that are disposed to receive the radiated linearly polarized modes as described elsewhere herein 156.

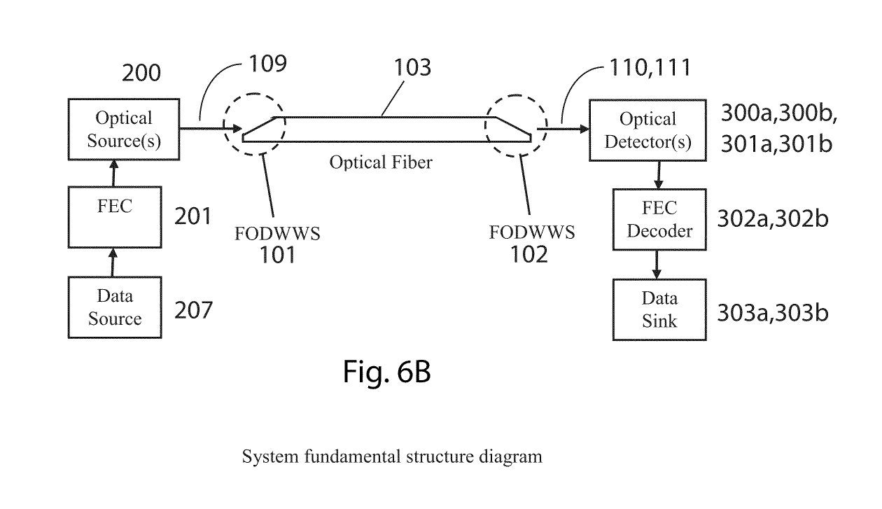

Referring now to FIGS. 6A and 6B, an exemplary system block diagram of an embodiment of the multichannel communication system of the invention is depicted. For each independent communication channel of a plurality of independent communication channels, a data source 207 may produce information to be transmitted, for example in the form of raw digital data, which information may be encoded by an encoder 201 which may employ Forward Error Correction (FEC) coding or other coding techniques known in the art of data communication systems. The raw data, or encoded data if FEC is employed, may be used to modulate an optical source 200 which may be, for example, a laser diode. The optical source 200 may then transmit optical energy 109 comprising the modulated data into an optical fiber 103 by illuminating an FODWWS on the input end 101 of optical fiber 103 that may comprise an FODWWS structure on both ends forming an FODWWS input end 101 and an FODWWS output end 102. Optical energy may propagate along fiber 103 and subsequently radiate from the FODWWS output end 102 of the optical fiber, illuminating at least one optical detector which may be a photodetector diode 300a or 300b. Optical detector 300a or 300b operates to convert the received optical energy 110 or 111 into a electrical signal, which is then communicated to a receiver 301a or 301b. Receiver 301a or 301b may operate to convert the electrical signal to a demodulated digital signal which is subsequently communicated to decoder 302a or 302b for decoding, producing a decoded digital baseband signal. In the instance where the system comprises FEC, decoder 302a or 302b may comprise an FEC decoder. The decoded baseband signal is then communicated to a data sink 303a or 303b as appropriate. In the case where multiple channels of information are desired to be multiplexed in the communication system the invention, the invention may comprise a plurality of independent communication channels. Thus, a plurality of data sources 207 may communicate independent baseband signals to a plurality of encoders 201, which may the communicate the encoded signals to a plurality of optical sources 200, which may optically illuminate an input FODWWS end 101 of an optical fiber, exciting independent optical modes in optical fiber 103, each mode comprising and independent data channel within optical fiber 103. Each independent optical mode may propagate along optical fiber 103 to output FODWWS end 102 where each mode exits optical fiber 103 as radiated optical energy 110 or 111, illuminating individual photodetectors 300a or 300b, which convert the received optical energy to an electrical signal that is communicated independently to individual receivers 301a and 301b for demodulation, producing a plurality of independent demodulated digital signals, one signal for each channel, which are subsequently communicated to individual decoders, producing a plurality of independent decoded baseband digital signals which are communicated independently to individual data sinks.

Still referring to FIGS. 6A and 6B, encoders(s) 201 are in communication with at least one, but preferably a plurality, of optical source(s) 200, which may be light emitting diodes, laser diodes, or any optical source capable of transmitting optical energy. Optical excitation source(s) 200 may each be in optical communication with input FODWWS end 101 which is part of optical fiber 103, illuminating input FODWWS end 101 with optical energy 109 and excited at least one optical mode in optical fiber 103. Output FODWWS 102, which is also part of optical fiber 103, may be in optical communication with photo detectors 300a or 300b, which may be the photodetector arrays 300a and 300b depicted in FIG. 10, and which are disposed to individually receive the individual radiated standing wave modes, radiated linearly polarized modes, or both, from output FODWWS 102. Each photodetector 300a or 300b may be in electrical communication with a receiver 301a or 301b. Thus, the system of the invention may comprise a plurality of encoders 201, a plurality of optical excitation sources 200, a plurality of photo detectors 300a and 300b, a plurality of receivers 301a and 301b, and a plurality of decoders 302a and 302b, together forming a plurality of separate, independent communication channels in which each encoder 201 is in electrical communication with a particular optical excitation source 200, and wherein each optical excitation source 200 is in optical communication with input FODWWS end 101 and establishes a particular propagating optical mode in fiber 103, and wherein each particular propagating optical mode is, in turn, radiated from output FODWWS 102 to a particular photodetector 300a and 300b that is in optical communication with output FODWWS end 102 and where each which particular photodetector 300a and 300b is, in turn, in communication with a particular receiver 301a or 301b, and where each which particular receiver 301a and 301b is, in turn, in communication with a particular decoder 302a or 302b which are in turn in communication with particular data sinks 303a or 303b all forming a plurality independent communication channels that comprise the multichannel modal communication system of the invention. FEC may optionally be employed to reduce the effect of intermodal interference, or crosstalk between modes that arises from the coupling of energy into input FODWWS 101 from optical excitation sources 200, from propagation of the various modes in optical fiber 103, or from radiation of the various modes from output FODWWS 102. In the embodiment in which the system of the invention does not comprise FEC or other encoding, data source(s) 207 may be in direct communication with laser sources 200, and receivers 301a and 301b may be in direct communication with data sinks 303a and 303b.

The invention may use the FODWWS to both excite and output linearly polarized modes in the few mode fiber. Standing waves created by the receiver cylindrical wedge may also be modulated by additional lasers in and embodiment of the invention. This is done to simplify the process of exciting optical modes in the fiber, and outputing optical modes from output FODWWS 102. The invention does not require complex interfaces as do methods, and is thus easily adaptable for mass production. No harsh chemicals are used that may create personnel safety issues or harm the environment. The invention is simple and straight forward as opposed to other methods of modal multiplexing and de-multiplexing.

Lasers typically may be characterized by a spot size. The spot size will vary in diameter as the distance of the laser source from the fiber being excited increases or decreases. In one embodiment, the invention may focus the energy of a second laser onto specific modes by the position in the core of a few mode fiber. With the established field and resonant modes already created, the second or plurality of lasers that will excite the modes must control excitation amplitude. Controlling the amplitude of the modal excitation lasers aids in the prevention of inter modal modulation. This invention then uses wave guide equations to define the phase, amplitude and radiation from the receiver end of the fiber. This is different from that of Murshid et al. who excite the source end of the fiber by angling the laser into the core to achieve a skew ray.

Skew rays are determined by high frequency techniques which make certain assumptions. The first is that the wave length of the laser source is much smaller than the core diameter. By exciting the multi-mode fiber with numerous sources and constant powers, a laser spot size will have a much higher probability of creating phase and modulation variations prior to the numerous core-cladding reflections experienced along the axial length of the multimode fiber. Linear polarized modes are simplified in the Gloge diagram by making the assumption that the radial components of the core and cladding indices are very small. These same interfaces and reflections will create inter modal interference. By conducting many interference patterns at the same wave length and amplitude, individual channels of modal modulation are significantly more complex and difficult to achieve—which is a significant drawback to the systems and methods of the prior art. The present invention simplifies that modulation and propagation.

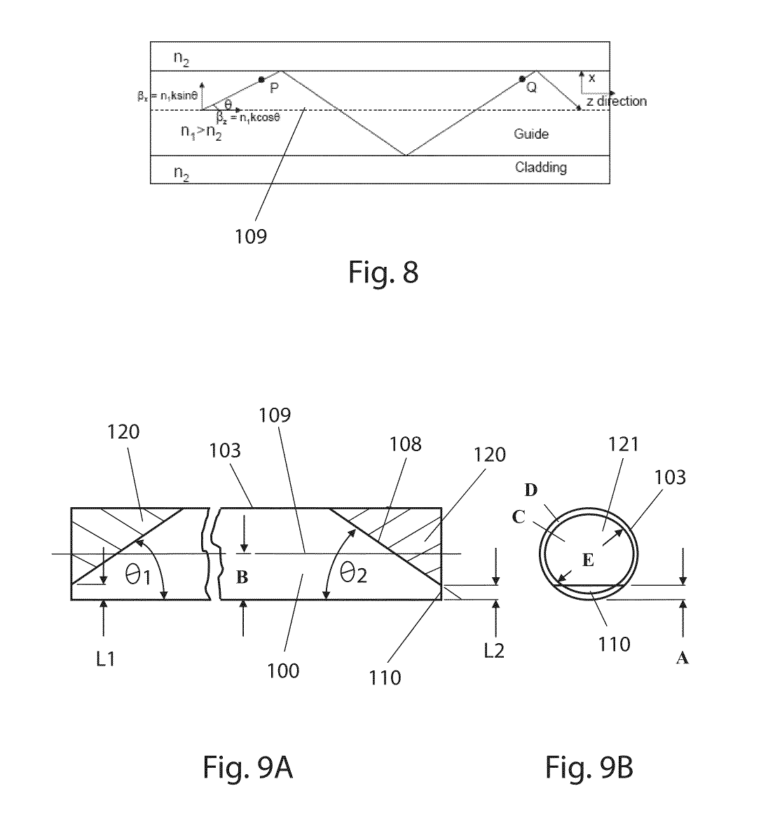

Referring now to FIGS. 9a and 9b, the system and method of the invention may comprise an FODWWS on both ends of an optical fiber, which may be but is not necessarily a few mode fiber as is herein described. Both the source and receiving end of a few mode fiber FODWWS may be shaped into a cylindrical wedge which may include a lip, as shown in FIGS. 9a and 9b and may be created by using a mechanical polishing process. The mechanical polishing process of the method of the invention is significantly easier to reproduce on a mass fabrication level than the chemical etching process. The mechanical polishing process of the invention enables observation of the excitation source radiation from the bottom of the cylindrical wedge as it is being shaped. Linearly polarized and standing dielectric waveguide modes are created and controlled by the polishing process that will adjust and create an elliptical core/cladding and air interface. This interface of the invention establishes the evanescent field which both reflects the energy below the bottom of the fiber wedge and back to the source for standing wave guide modes. It is this electric and magnetic field behavior that allows for both modal multiplexing and de-multiplexing of this invention.

The present invention comprises a process of creating the few mode fiber cylindrical wedge as a mechanical process as opposed to the chemical processes of the prior art. In the prior art, only the multimode fiber tip was shaped into a cone to allow modal radiation in the form of modal rings. The shape of the fiber end will affect the radiation of energy from the fiber. In order to create a process that is friendly to mass production, the hydrofluoric acid used in previous work must be replaced by a more user friendly and environmentally friendly process. Cleaving the angle as desired achieves the same function as the mechanical process if the angle can be achieved for the specific desired radiation pattern of the modal energy. In this invention, the desired angle to be polished is determined by computer aided design tools capable of simulating the electromagnetic standing and hybrid modes of the dielectric filled waveguide structure. The waveguide structure in this invention is preferably a step index few mode fiber.

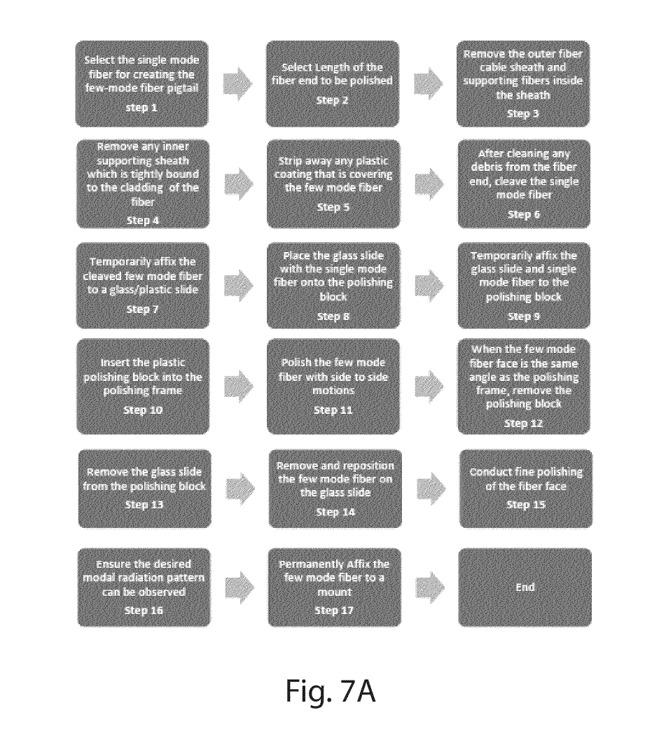

An example of one embodiment of the novel method and fixtures for shaping the cylindrical wedge for this invention is provided by FIGS. 7a, 7b, and 7c. In this exemplary depiction of one embodiment of the manual mechanical polishing process of the invention, a novel method for fabrication of an FODWWS of the invention is depicted. The particular method depicted in FIGS. 7a, 7b, and 7c is exemplary; it is understood that the scope of the invention includes all equivalent steps. The invention includes all equivalent steps for mechanical polishing of an optical fiber that are capable of creating the FODWWS.

In the mechanical polishing methods of the invention, care must be taken to not over heat the surface of the fiber optic wedge. The method must ensure that the consistent permittivity and permeability of the cylindrical waveguide are not affected by overheating of the FODWWS planar surface (depicted as angled end face planar surfaces 107 and 108 in FIG. 4). After the FODWWS is fabricated, modulation of the data can be achieved by the addition of heat to the fiber. In this example the manual method described uses a mechanical fixture to create the desired shape. Each step of the mechanical polishing method of the invention is depicted in the flow chart of FIG. 7a. FIGS. 7b and 7c depict the mechanical polishing fixture of the invention that may be used to carry out the mechanical polishing method of the invention. Each step of FIG. 7a is described below, with references to FIGS. 7b and 7c.

Step 1 of the mechanical polishing method of the invention is the selection of an optical fiber to be used in creating the FODWWS. The fiber may be a few mode fiber, a single mode fiber, or a multimode fiber. Typically a the optical fiber also includes other elements of a cable and therefore the fiber may also comprise an outer sheath, inner strengthening fibers, inner sheath and plastic coating on the cladding of the fiber.

Step 2 of the mechanical polishing method of the invention may be selecting the length of the optical fiber to be utilized in the modal multiplexed communication system. The length of the optical fiber is generally determined by the length optical fiber needed for a particular application. However, the length of the fiber must be long enough to reach from the optical source and onto the polishing block.

Step 3 of the mechanical polishing method of the invention is the removal of the outer sheath and inner supporting fibers just below the sheath which may cover the optical fiber. Placing the fiber onto a glass slide requires that at least twice the length of the outer sheath 300 and the reinforcing strands 301 be removed, typically by cutting. This will expose an inner sheath 302 also used to support and protect the optical fiber. This material should not be allowed to contaminate the polishing process or the face of the cylindrical wedge can become scratched.

Step 4 of the mechanical polishing method of the invention is to remove the inner sheath 302 supporting the few mode fiber. Again the length removed of the inner sheath 302 must be enough to allow the fiber to be placed onto glass slide 304. During the mechanical polishing process, the cladding and core should be flat on the surface of glass slide 304.

Step 5 of the mechanical polishing method of the invention is the removal of the plastic coating on the outside of the cladding. Those skilled in the field will remove the coating prior to cleaving the fiber. Any coating on the fiber will not allow the fiber to be properly cleaved so as to produce a planar fiber end face at 90 degree angle to the longitudinal axis of the optical fiber.

Step 6 of the mechanical polishing method of the invention is the cleaning and subsequent cleaving of the optical fiber. Prior to the mechanical polishing of optical fiber 303, the fiber is cleaved at a 90 degree angle. While cleaving by thermally heating or arching of the fiber may be used in the method of the invention, it can cause a change in the optical fiber's characteristics. Mechanical cleaving of the optical fiber 303 is the best method, but not the only method, for producing a 90 degree angle on the fiber end face. Evaluation of the cleaved end is important: the cleaved fiber end face must be a smooth surface, and no cracked or broken cladding at the end of the fiber can be present. During the polishing step of the method, if a cladding breakage is not prevented, the radiation patterns will not be adequate for communication and sensing applications.

Step 7 of the mechanical polishing method of the invention is the mounting of the optical fiber onto a glass slide. The freshly cleaved optical fiber, 303, is temporarily affixed onto glass slide 304. The end of the optical fiber is preferably allowed to extend about the width of the fiber cladding diameter beyond the edge of slide 304. The optical fiber cladding is preferably disposed flat on slide 304 by trimming any inner sheath, 302, so that it does not interfere with fiber 303 lying flat on glass slide 304. Fiber 303 is preferably disposed perpendicular to glass slide 304 to allow a symmetric flat polishing of the tip. Glass slide 304 is preferably glass so that the slide is of the same type of material as optical fiber 303. Dissimilar material might score or scratch the surface of the FODWWS. The angled end face of the FODWWS surface is preferably polished smooth to create an evanescent field.

Step 8 of the mechanical polishing method of the invention is to temporarily place the cleaved fiber onto a polishing block 308. This is done by inserting polishing block 308 into polishing frame 305; pushing the polishing block back until it is flush with foam pad 306 on polishing frame 305; and sliding glass slide 304 with the few mode fiber flush against foam pad 306 of the polishing frame.

Step 9 of the mechanical polishing method of the invention is to temporarily affix glass slide 309 onto the polishing block 308. This may be accomplished with either a temporary chemical adhesive or tape. It is important to ensure polishing block 308 and glass slide 309 are perpendicular to the few mode fiber extending just over the edge of the glass slide. As a optional test step, polishing block 308 may be removed from polishing frame 305, and glass slide 309 and polishing block 308 should not slip.

Step 10 of the mechanical polishing method of the invention is to replace polishing block 308 back into polishing frame 305. This steps of the method require at least one but preferably three levels of fiber optic polishing paper, course, medium and fine, in that order, be placed onto the foam pad 306. Polishing will generally, but not always, require course, medium and fine fiber optic polishing paper. For the initial shaping of the cylindrical wedge of the FODWWS, a course fiber optic polishing paper is generally be used. Next, the medium fiber optic is used. The final step is to polish the angled face of the FODWWS with a fine fiber optic polishing paper.

Step 11 of the mechanical polishing method of the invention is to polish the fiber by lightly moving polishing block 308 back and forth. The use of a course fiber optic polishing paper will cause the angled end face of the FODWWS to take on the angle θ of polishing frame 305. This may be any angle from 5 degrees to 89 degrees. The angle is dependent on the radiation pattern desired. For a radiated pattern that is radiated below and aft of the FODWWS, angles between 5 and 40 degrees are formed by the polishing. This range of angles will be cause semi-circle rings radiated back and below the cylindrical wedge to be formed. A radiated pattern just below the polished fiber will occur at an angle of 45 degrees. This is the optimum angle for de-multiplexing both the linearly polarized and standing wave modes of the dielectric waveguide. Polishing the angles beyond 60 degrees will create radiated circles. In order to create the linearly polarized modes as small arches, the surface of the polished wedge preferably comprises a reflective surface such as the reverse side or shiny side of the fiber optic polishing paper. By doing this the wedge will radiate both linearly polarized modes and standing wave modes.

Application of a fluid such as water may be important in the process of creating the FODWWS wedge. Water will remove polishing dust and keep the surface of the fiber cool. The frame 305 may comprise a gap between polishing block 308 and the foam pad 306, allowing water to drip onto the lower part of the frame and carry polishing debris with it.

The angle for polishing is dependent on the radiation pattern desired. Since the FODWWS wedge is also a radiating element, the reverse of the radiation can be achieved. By shaping the cylindrical wedge and then allowing an optical source such as a laser to focus energy into the bottom of the cylindrical wedge and striking the correct location on the surface of the wedge, an individual mode can be modulated. Adjusting a laser to modulate more than one mode will result in wave length division multiplexing.

Step 12 of the mechanical polishing method of the invention is the removing of polishing block 308 from polishing frame 305 and inspecting the FODWWS cylindrical wedge planar surface. This step may be repeated to ensure that angle θ is correct and that the fiber was not damaged in the manual polishing process. If the fiber was damaged, steps 1 through 12 may be repeated. If the polishing paper on foam polishing pad 306 is to be replaced, the process may be re-started at step 10 after the polishing paper is replaced.

Step 13 of the mechanical polishing method of the invention is the removal of temporarily affixed glass slide 309 and fiber 303 from the polishing block. This is done by removing the temporary glue or tape holding the slide onto the polishing block.

Step 14 of this invention requires that the fiber be removed from the glass slide 309 onto polishing block 308. Step 14 of the mechanical polishing method of the invention comprises removing fiber 303 from glass slide 309 and repositioning fiber 303 onto glass slide 309 for final polishing by removing the temporary glue or tape and lifting fiber 303 from glass slide 309. By allowing an optical source such as a laser to excite the input FODWWS cylindrical wedge, the radiation pattern can be observed. This allows easier positioning of fiber 303 back onto glass slide 309. Once the radiation pattern is clearly seen at the desired position, fiber 303 is placed back onto glass slide 309 as in step 7, allowing just enough fiber 303 to extend past the edge of glass slide 309 for fine polishing.

Step 15 of the mechanical polishing method of the invention requires that the FODWWS cylindrical wedge be fine polished. This step enables the radiated energy produce a clear pattern below the curved section of the FODWWS cylindrical wedge. Fine polishing is the adjustment of the cylindrical wedge to reflect energy from the bottom of the fiber to the surface of the FODWWS cylindrical wedge. Fine polishing on the permanent fixture is achieved in this particular embodiment by using fine polishing paper to polish the planar cylindrical wedge surface of the FODWWS. Polishing of the cylindrical wedge is best accomplished using figure-eight motions to ensure that a smooth and scratch-free surface is achieved on the planar cylindrical wedge surface of the FODWWS.

Step 16 of the mechanical polishing method of the invention is the step of ensuring the FODWWS fiber cylindrical wedge is radiating the semi circles, rings or linearly polarized mode(s) at the desired locations. Measuring the modulation of the modes is achieved by ensuring the modal arches are illuminating the appropriate linear array detectors of this invention.

Step 17 of the mechanical polishing method of the invention is placing the FODWWS cylindrical wedge onto a permanent fixture to meet the needs of the application.

The present invention comprises the formation of a fiber optic dielectric wave guide structure FODWWS on an optical fiber a input end, output end, or both. The invention may comprise a few mode fiber shaped into an FODWWS cylindrical wedge on one or both ends, as shown in FIG. 4. The mechanical polishing method of the invention is significantly easier to reproduce on a mass fabrication level than the chemical etched process of the prior art. In an alternative embodiment of the method of producing the planar cylindrical wedge surface of the FODWWS of the invention, the optical fiber may be directly cleaved to the desired angle to produce the planar cylindrical wedge surface of the FODWWS at a desired angle θ to the longitudinal axis of the optical fiber. Cleaving the optical fiber to produce the planar cylindrical wedge surface of the FODWWS as desired achieves the same function as the mechanical process if angle θ can be achieved for the specific desired radiation pattern of modal energy. In this invention, the desired angle to be polished may be determined by computer aided design tools capable of simulating the electromagnetic standing and hybrid modes of the dielectric filled waveguide structure. The waveguide structure in this invention is preferably a step index few mode fiber, but may be graded index fiber, and may be multimode or single mode fiber.

This invention embodies the modal multiplexing and de-multiplexing system of a cylindrical dielectric waveguide, or fiber optic waveguide, with a at least one cylindrical wedge mechanically polished on either or both ends of the few mode fiber forming an FODWWS. The invention utilizes linearly polarized and standing waveguide modes established by the FODWWS structure located at one or both ends of an optical fiber. the invention, unlike other work conducted in the field, does not simplify the linear polarized field equations to a set of four differential equations to model the modal multiplexing and de-multiplexing. The invention includes the z direction or axial field equations of the cylindrical waveguide structure. This is desired based on the internal reflections of both the core cladding interface and the source and receiver axial ends of the few mode fiber. Linearly polarized modes are created by the very small difference between the core and cladding indices. This small difference in indices allows for the existence of hybrid Electric Magnetic fields (EH) and the Magnetic Electric fields (EH) to propagate simultaneously. This allows for significant simplification of the linearly polarized fields to four field equations.

With the existence of standing waves which are created by the evanescent field reflectors of the cylindrical wedge FODWWS' mechanically polished on the surface of the fiber, the ends are an elliptical core-cylindrical core interface. This interface which is also a core/cladding to air interface establishes an evanescent field. The evanescent field creates axial or z forested reflections that establish cylindrical waveguide standing waves and also radiates the fields from below the bottom of the cylindrical wedge. This radiation pattern is very different from the previous work of Murshid et al.

Modulation of established waveguide modes is achieved by first establishing a fundamental source laser field within the multiplexer/de-multiplexer fiber optic pigtail. Once the linearly polarized and standing wave modes are stabilized, a plurality of laser sources that radiate into specific points of the source cylindrical wedge can affect the standing and linearly polarized fields. By controlling the amplitude of the allowed electric field or mode, amplitude modulation can be achieved. Shifting the pulsing period of two or more input lasers allows for phase modulation by the offset timing of pulsing energy. Frequency modulation can be achieved by changing the wavelength of the source laser.

Modal multiplexing and de-multiplexing of this invention is achieved by the modulation of allowed electric fields (modes) of the dielectric cylindrical waveguide. This invention can create the standing waves of both linearly polarized modes and standing wave modes by the source excitation laser coupled into a standard fiber optic connector such as the FIS connector. However, a source or input cylindrical wedge is required to create the selected modal modulation by the excitation sources. Exciting the perfectly cleaved 90° input face of a cylindrical dielectric wave guide with multiple laser sources will establish a significant number of hybrid electric and magnetic fields from the core/cladding interface. As Kerr et al. has demonstrated, this interface will create significant inter modal modulation as a result of the very small indices difference between the core and cladding material. The mode field diameter of the few mode fiber will act as filter to reduce the intermodal modulation that would make demodulation more difficult.

The FODWWS cylindrical wedge that comprises the modal multiplexer and de-multiplexer of the invention should preferably be created reliably and with a high degree of repeatability. Previous work in the field has demonstrated the use of hydrofluoric acid as a means of etching fiber cones. This method leaves the very un-repeatable and no-reliability of the shaped fibers for mass production. The mechanical polishing process presented is an example of the polishing process which might be used. This process shapes the angle of the fiber consistently and with very little skill level in the art required. Using the system and method of the invention, the polishing technician is not subjected to the harsh and potentially lethal chemicals, such as hydrofluoric acid, to shape the fiber end. A traditional chemically-etched fiber end may also be extremely brittle; the mechanically polished cylindrical wedge is much more robust and durable. The system and method of the invention are ideal for mass production of the modal multiplexing and de-multiplexing fiber optic cylindrical wedge pigtail.

The invention comprises multiplexing and de-multiplexing of modal energy in an optical fiber which is operated at a wavelength that may establish a plurality of modes, may be achieved by a system of a plural of laser excitation sources, a few mode fiber with both ends of the modal multiplexing and de-multiplexing FODWWS polished to establish cylindrical wedges, and a linear array of a plural of laser detectors. This invention also establishes the modal multiplexing achieved by the cylindrical wedge. Any mechanical polishing process that does not change the material characteristics of permeability may be used to shape the optical fiber end into a cylindrical wedge. The most effective fine tuning of the radiated fields is achieved in this invention by simultaneously polishing the fiber and observing the radiated fields as radiated onto the linear array of detectors.

In the invention the key component is the FODWWS which is demonstrated in FIG. 4. Three fundamental parameters are considered for the modal source excitation and transmission into the detector array. The first is the angle θ at which the flat surface is polished. The second is the height of the lips L1 and L2 at the end of the angled surface. The third parameter are the fiber optic core/cladding dimensions.

A specific propagating mode may be obtained when the angle between the propagation vectors, or rays, and the fiber end face has a particular value. The propagation of specific modes is dependent upon the angle between the propagation vector, or rays of light, and the physical end face of the optical fiber. It is therefore an object of fiber-optic communication and sensor systems to efficiently and repeatedly create optical fiber interfaces with known and predictable characteristics that may be characterized as supporting specific modes, and may also be characterized as exhibiting specific behavior when propagating modes exit a fiber end face where there exists a fiber-to-air boundary.

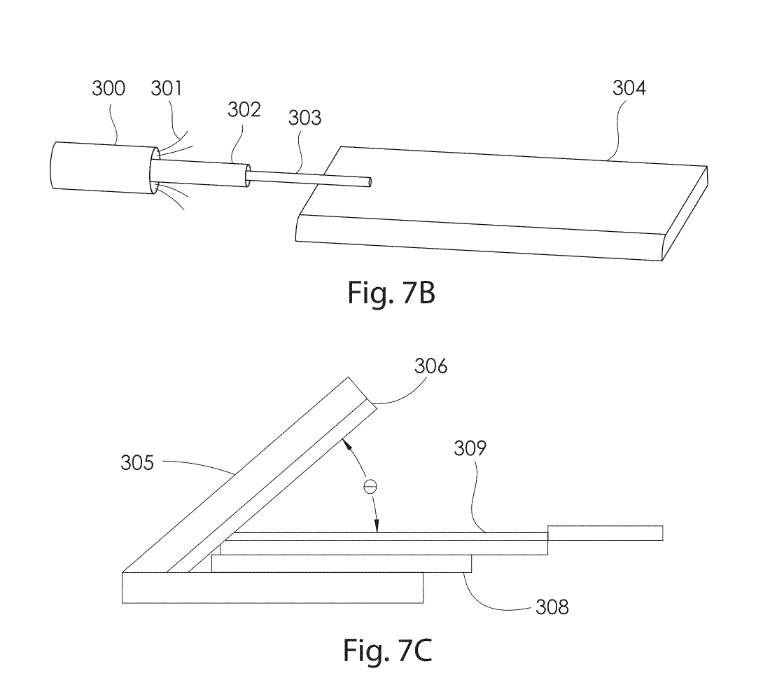

Referring to FIG. 8, the behavior of light energy as it passes from a first medium having an index of refraction n₁ to a second medium having an index of refraction n₂ may be defined by Snell's law:

n₁ sin(θ₁)=n₂ sin(θ₂)

where:
n₁ is the refractive index of the medium the light is leaving;
θ₁ is the incident angle between the light beam and the normal (normal is 90° to the interface between two materials);
n₂ is the refractive index of the material the light is entering; and
θ₂ is the refractive angle between the light ray and the normal.

When a light ray crosses an interface into a medium with a higher refractive index, it bends towards the normal. Conversely, light traveling cross an interface from a higher refractive index medium to a lower refractive index medium will bend away from the normal. At an angle known as the critical angle θc light traveling from a higher refractive index medium to a lower refractive index medium will be refracted at 90°; in other words, refracted along the interface. If a ray of light hits the interface at any angle larger than this critical angle, it will not pass through to the second medium. Instead, it will be reflected back into the first medium, a process known as total internal reflection. The critical angle can be calculated from Snell's law, using an angle of 90° for the angle of the refracted ray θ2. For example, a ray emerging from glass with n1=1.5 into air (n2=1), the critical angle θc is arcsin(1/1.5), or 41.8°.

For any angle of incidence larger than the critical angle, Snell's law will not be solved for the angle of refraction because the refracted angle would have a sine larger than 1, which is not possible. In that case all the light is totally reflected off the interface.

Still referring to FIG. 8, the longitudinal axis of the optical fiber is indicated as element 104. It is known in the art that the outer surface of the optical fiber is typically cylindrical in shape and is disposed about longitudinal axis 104.

Referring now to FIGS. 9a and 9b, a side view and an end view, respectively, of a preferred embodiment of the fiber optic dielectric waveguide structure are depicted. An optical fiber 103, typically comprising a core C comprising an outer core diameter E, and a cladding D disposed concentrically about cladding C of thickness CW (depicted in FIG. 4) in which the core C and cladding D are generally, but not necessarily, of differing indices of refraction and supporting, in the best mode of the invention, a few propagating modes of light energy in optical fiber 103, is modified by removing from the optical fiber the volume 120 shown in cross hatch in FIG. 9a. Volume 120 may be removed from optical fiber 103 by any means known in the art such as cleaving or mechanical polishing. The best mode and preferred embodiment of the invention utilizes mechanical polishing to create surface 108, resulting in a polished planar surface 108 that is disposed at an angle θ₂ taken from the outer diameter of the optical fiber, which is typically the outer diameter of the optical fiber cladding. It can be seen that, as the outer diameter of the optical fiber is typically cylindrical about longitudinal axis 109, the angle between surface 102 and longitudinal axis 104 is θ₂ as well. As the typical optical fiber comprises a core and a cladding surrounding the core, the optical fiber outer diameter is, in the typical case, the outer diameter of the cladding. Angles θ₁ and θ₂ may be any angle measure between 5 degrees and 90 degrees. The desired measure of θ₁ and θ₂ may vary based upon the excitation source and whether it is desired to radiate standing wave modes or Linearly Polarized (LP) modes from the fiber optic dielectric waveguide structure.

Still referring to FIGS. 9a and 9b, a lip surface 110 is created by the removal of volume 120. Lip surface 110 may also be mechanically polished using any of the techniques known in the fiber optic art. Lip surface 110 may take the dimension L1 on the FODWWS input end, or dimension L2 on the FODWWS output end as is shown in FIGS. 9a and 9b. Dimension L1 and L2 are typically, but not necessarily, the same, and they are typically, but not necessarily, greater than the cladding thickness and are less than dimension B as shown in FIG. 9a, which is the distance between the longitudinal axis of the optical fiber and the outer diameter of fiber 103 (which is typically the outer diameter of the cladding D). The lip surface 110 of dimension L1 and L2 is responsible in part for generating and determining which modes to the output.

The invention also comprises a method of manufacturing a dielectric waveguide FODWWS having an angled planar surface and lip surface as shown, for example, as lip surface 110 in FIGS. 9a and 9b, which method may comprise the steps of:
a. Providing an optical fiber having a longitudinal axis, a core and a cladding, wherein said cladding is further defined as having a thickness;
b. Cleaving said optical fiber at a desired angle to the longitudinal axis of the fiber;
c. Creating a planar surface on said optical fiber by mechanically polishing said fiber at an angle α, wherein said angle α may take any measure between 5 degrees and 90 degrees, and leaving a lip surface that is not co-planer with said planar surface; and
d. Mechanically polishing said lip surface.

Step a. of the method of the invention may further define the optical core and cladding as being concentric about a longitudinal axis of the optical fiber.

Step b. of the method of the invention may further define the optical fiber as supporting a few modes, or may be step or graded index fiber, or may be single or multi-mode fiber, or any combination of these.

Step c. of the method of the invention may further define the planar surface as being adapted to transmit linear polarized and standing wave modes of optical energy from the fiber into free space.

Step d. of the method of the invention may further define the lip surface as being perpendicular to the longitudinal axis, and of a dimension that is much greater than the cladding thickness.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

What is claimed is:

1. A system for multichannel modal communication comprising:
an optical fiber, said optical fiber having a longitudinal axis, an input end and an output end, wherein both of said input end and said output end comprise an angled planar surface disposed at an angle θ relative to said longitudinal axis, and wherein each of said angled planar surfaces further comprises a flat lip surface perpendicular to said optical fiber longitudinal axis;
at least one optical source in optical communication with said input end of said optical fiber, said at least one optical source capable of transmitting optical energy into said input end of said optical fiber thereby exciting at least one linearly polarized or at least one standing wave mode in said optical fiber;
at least one optical detector in optical communication with said fiber output end, disposed so as to receive optical energy comprising a linearly polarized or standing wave mode excited by said at least one optical source when said at least one linearly polarized or at least one standing wave optical mode is radiated from said optical fiber output end.

2. The system of claim 1,
wherein said at least one optical source comprises a plurality of optical sources, each optical source of said plurality of optical sources capable of transmitting optical energy into said input end of said optical fiber thereby exciting at least one linearly polarized or at least one standing wave mode in said optical fiber that is independent from all other optical modes excited by the other optical sources of said plurality of optical sources; and
wherein said at least one optical detector comprises a plurality of optical detectors in optical communication with said output end of said fiber, each detector disposed so as to receive an independent radiated linearly polarized or standing wave mode optical mode radiated from said output end of said optical fiber.

3. The system of claim 2, wherein at least one of said plurality of optical sources is further defined as being in independent optical communication with at least one of said plurality of optical detectors through said independent linearly polarized or standing wave optical mode, forming an optical source-optical detector pair in independent communication through an independent excited optical mode in said optical fiber.

4. The system of claim 3, wherein each of said plurality of optical sources is further defined as being in independent optical communication with at least one of said plurality of optical detectors, forming a plurality of optical source-optical detector pairs in independent communication through an independent excited optical mode in said optical fiber, collectively forming a plurality of independent optical communication channels.

5. The system of claim 1 wherein said at least one optical source comprises at least one laser diode.

6. The system of claim 2 wherein said plurality of optical sources comprises at least one laser diode.

7. The system of claim 3 wherein said plurality of optical sources comprises at least one laser diode.

8. The system of claim 4 wherein each of said plurality of optical sources comprises a laser diode.

9. The system of claim 1, wherein angle θ is between 5 and 90 degrees.

10. The system of claim 2, wherein angle θ is between 5 and 90 degrees.

11. The system of claim 3, wherein angle θ is between 5 and 90 degrees.

12. The system of claim 4, wherein angle θ is between 5 and 90 degrees.

13. The system of claim 1, further comprising:
at least one encoder in communication with said at least one optical source, said at least one encoder capable of receiving baseband data from a data source, encoding said baseband data, and outputting encoded data to said at least one optical source; and
at least one receiver in communication with said at least one optical detector; and
at least one decoder in communication with said at least one receiver;
wherein said at least one receiver is capable of receiving data from at least one optical detector; and
wherein said at least one decoder is capable of receiving encoded data from said receiver, decoding said encoded data, and outputting baseband data to a data sink.

14. The system of claim 2, further comprising:
a plurality of encoders, each encoder of said plurality of encoders in communication with one of said plurality of optical sources, each of said encoders capable of receiving baseband data from a data source, encoding said baseband data, and outputting encoded data to one of said plurality of optical sources; and
a plurality of receivers, each receiver of said plurality of receivers in communication with one of said plurality of optical detectors; and
a plurality of decoders, each decoder of said plurality of decoders in communication with one of said plurality of receivers;
wherein each receiver of said plurality of receivers is capable of receiving data from one of said plurality of optical detectors; and
wherein each decoder of said plurality of decoders is capable of receiving encoded data from one receiver of said plurality of receivers, decoding said encoded data, and outputting baseband data to a data sink.

15. The system of claim 3, further comprising:
a plurality of encoders, each encoder of said plurality of encoders in communication with one of said plurality of optical sources, each of said encoders capable of receiving baseband data from a data source, encoding said baseband data, and outputting encoded data to one of said plurality of optical sources; and
a plurality of receivers, each receiver of said plurality of receivers in communication with one of said plurality of optical detectors; and
a plurality of decoders, each decoder of said plurality of decoders in communication with one of said plurality of receivers;
wherein each receiver of said plurality of receivers is capable of receiving data from one of said plurality of optical detectors; and
wherein each decoder of said plurality of decoders is capable of receiving encoded data from one receiver of said plurality of receivers, decoding said encoded data, and outputting baseband data to a data sink.

16. The system of claim 4, further comprising:
a plurality of encoders, each encoder of said plurality of encoders in communication with one of said plurality of optical sources, each of said encoders capable of receiving baseband data from a data source, encoding said baseband data, and outputting encoded data to one of said plurality of optical sources; and
a plurality of receivers, each receiver of said plurality of receivers in communication with one of said plurality of optical detectors; and
a plurality of decoders, each decoder of said plurality of decoders in communication with one of said plurality of receivers;
wherein each receiver of said plurality of receivers is capable of receiving data from one of said plurality of optical detectors; and
wherein each decoder of said plurality of decoders is capable of receiving encoded data from one receiver of said plurality of receivers, decoding said encoded data, and outputting baseband data to a data sink.

17. The system of claim 13, wherein said at least one encoder is further defined as capable of performing Forward Error Correction encoding, and wherein said decoder is further defined as capable of performing Forward Error Correction decoding.

18. The system of claim 14, wherein said at least one encoder is further defined as capable of performing Forward Error Correction encoding, and wherein said decoder is further defined as capable of performing Forward Error Correction decoding.

19. The system of claim 15, wherein said at least one encoder is further defined as capable of performing Forward Error Correction encoding, and wherein said decoder is further defined as capable of performing Forward Error Correction decoding.

20. The system of claim 16, wherein said at least one encoder is further defined as capable of performing Forward Error Correction encoding, and wherein said decoder is further defined as capable of performing Forward Error Correction decoding.

21. The system of claim 1, wherein said optical fiber is defined as a few mode fiber.

22. The system of claim 2, wherein said optical fiber is defined as a few mode fiber.

23. The system of claim 2, wherein said optical fiber is defined as a few mode fiber.

24. The system of claim 2, wherein said optical fiber is defined as a few mode fiber.
